(19) United States
(12) Patent Application Publication
(10) Pub. No.: US 2011/0073536 A1
(43) Pub. Date: Mar. 31, 2011

(54) SUBSTAINABLE TECHNOLOGY FOR TREATMENT OF BATIK WASTE EFFLUENT

(76) Inventors: Zularisam ABDUL WAHID, Kuantan (MY); Mimi Sakinah Abdul Munaim, Kuantan (MY)

(21) Appl. No.: 12/769,667

(22) Filed: Apr. 29, 2010

(30) Foreign Application Priority Data
Sep. 29, 2009 (MY) PI 20094064

(51) Int. Cl. C02F 1/44; B01D 35/00; C02F 3/12; B01D 71/68; B01D 67/00

(52) U.S. Cl. 210/202; 210/205; 264/183

(57) ABSTRACT

The treatment system known as SMBR for treatment of batik waste effluent, said system combines the activated sludge process with a semi permeable bio-membrane submerged in the process water that is capable of treating and filtering particulate waste constituents from the mixed liquor solution of batik effluent, thus subsequently provide treated batik effluent of high quality, reusable and particle free effluent. The semi-permeable membrane (bio-membrane) (7) has a pore size of approximately 6 nm to provide permeate comprised of batik effluent compliant to the Standard A of regulations stipulated by the Department of Environment (DOE) Malaysia. Air scouring (8) is maintained in the body of water in the range of 1 LPM to 4 LPM for purpose of minimizing membrane fouling, subsequently lead to relatively stable suction operation at low transmembrane pressure (TMP below 1 bar), lesser hydraulic retention time (4-24 hours) and longer backwash requirement (30 days). Operational conditions of MLSS and SRT were maintained at the range of 4000 mg/L to 7000 mg/L and 16 days to 30 days, respectively. Besides that the system is also practical, compact and easy to upgrade.

### FIELD OF INVENTION

The present invention relates to a technology for use in treatment of textile-based waste effluent, more particularly to a Batik based wastes treatment technology, wherein environmental-friendly waste effluent is produced.

### BACKGROUND OF INVENTION

Batik is prominently known as a form of a hand-painted fabric, and produced widely in several South East Asian countries. Patterns of Batik are incorporated based on a variety of themes; such themes can be artistically crafted in accordance to everyday life events or of exclusive significance within an indigenous community. Batik industry plays a major role in the economic growth of these countries, considering the rapidly increasing demand locally and from abroad.

A typical Batik production method involves the preparation of the selected cloth for printing or painting, waxing, dyeing of cloth and removal of wax from the painted or printed cloth. Understandably, the production of Batik necessitates the use of numerous chemicals so as to aid in realizing these steps; particularly substances for application of dyes for providing patterns which are rich in color. Wastes generated from these steps consist of effluents containing residues from Batik production steps, such as liquid chemicals, grease, wax, surfactants, mordant, vat and in some cases, heavy metals.

Due to the substantial content of chemicals used, untreated liquid wastes generated from the Batik industry have been one of the key predicaments relating to environmental safety compliance within the respective nations. Following this, centralized efforts mostly in the development of ethical or proper disposal methods of these wastes have been gradually surfaced to alleviate the adversities of Batik industry wastes to the public and surroundings.

Although wastes treatments have been constructive and progressively urbanized for a great majority of other commerce industries, there are no standardized or rather effectual treatment methods implemented with respect to treating Batik wastes, particularly wastes effluent generated by the Batik production industry.

The above primary shortcoming therefore puts forward the development of the present invention to offer a better result in providing a more environmental friendly, sustainable and cost effective Batik effluents treatment method.

It is another object of the present invention to provide a method for the treatment of Batik waste effluents with convenience in handling and addresses environmental pollution predicaments of the Batik production industry.

Further objects and advantages with respect to the method of the present invention will become apparent in the following detailed description.

### SUMMARY OF INVENTION

The present invention discloses a method for use in treatment of textile-based waste effluent, wherein the treated effluent is meant to comply with the effluent discharge standard enforced by the Department of Environmental Malaysia (DOE). The invention is a submerged membrane bio reactor (SMBR) that integrates suspended bio mass (activated sludge), air scouring and a submerged semi-permeable membrane (bio-membrane) that aims to treat batik effluent efficiently. SMBR consists biological reactor with suspended biomass and solids/dissolved macromolecules separation done by the bio-membrane. SMBR is capable of completely separating dyes such as mordant, acid, vat and direct dyes from the brine, thus producing a more compliant discharge that is potential to be reused. In particular, Bio-membrane ensures effective separation due to its smaller membrane's pore size (approximately 6 nm) which can retain most of the partially treated micro particles and macro pollutants in batik effluent, thus subsequently producing treated batik effluent that meet and exceed the Malaysia Sewage and Industrial Effluent Discharge Standards. Furthermore the novelty of this invention comes not only from the technological, cost and environmental advantages offered by SMBR but also from the innovative design and fabrication of locally-made bio-membrane and its biological reactor system. Arrangement of optimal operating condition and processes of SMBR beneficially result in a more compliant batik effluent which can be reused in the next cycle of dyeing and rinsing processes. The treatment system performs under low energy consumption (below 1 bar/14.2 psi), short hydraulic retention time (4-24 hours) and compact footprint thus yielding tremendous economical results. The system is sustainable, compact, easily operable, economical and practical which proves to be beneficial for textile industry particularly the batik manufacturer.

### BRIEF DESCRIPTION OF THE DRAWINGS

FIG. 1 illustrates a schematic view of submerged membrane bio reactor (SMBR) which is installed to a batik factory. The batik effluent is transferred into an effluent collection tank (1) and passes through the submerged membrane bioreactor (SMBR) (2) for treatment. The treated batik effluent is then pumped (3) back to the batik factory's water storage for reusing purposes (4).

FIG. 2 illustrates a detailed view of SMBR which integrates a pretreatment phase (5), activated sludge or biological reactor phase (6), a submerged semi-permeable bio-membrane (7) and air scouring (8).

FIG. 3 illustrates scanning electron micrograph (SEM) of the cross-section of a (a) clean bio-membrane morphology, (b) dense skin layer and (c) inner skin.

### DETAILED DESCRIPTION

In line with the above summary, the following description of a number of specific and alternative embodiments is provided to understand the inventive features of the present invention. It shall be apparent to one skilled in the art, however that this invention may be practiced without such specific details. The present invention provides an effectual approach for treatment of Batik waste effluent and thus providing a more proper way of disposing liquid waste or effluent resulting from this chemical-intensive industry.

In a preferred embodiment of the present invention, there is provided a method incorporating the advantages of submerged membrane and a conventional activated sludge (CAS) used for various treatment technologies.

Submerged membrane bioreactor (SMBR) typically consists of a biological reactor with suspended biomass (municipal sludge) and provides solids or dissolved macromolecules separation by means of bio-membrane. For that reason, SMBR system incorporated with innovative membranes of the present invention is capable of providing systematic separation of dyes, including mordant, acid, vat and direct dyes from the brine.

It is understood that the operating steps of the submerged membrane bioreactor in relation to the method of the present invention may involve conventional steps however with substantial modifications so as to provide a more effective treatment and thereby obtain improved outcome.

The primary role of the submerged membrane bioreactor is to produce effluent with improved quality or sufficiently safe to be released to the surroundings. As discussed in the preceding paragraphs, the method of the present invention uses the bioreactor-membrane hybrid system with inventive modifications to finally generate a resultant batik waste effluent which is highly compliant to the Standard A and Standard B of regulations stipulated by the Department of Environment (DOE).

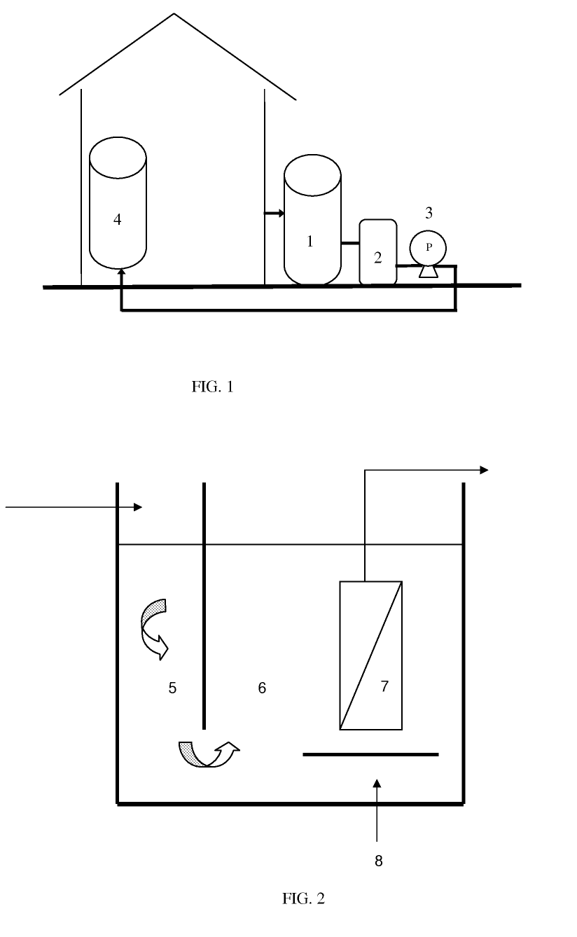

For the purpose of elucidation, as referring to FIG. 1, SMBR system in a single reactor tank is installed to a batik factory whereby the batik waste effluent is collected into an effluent collection tank (1). The batik effluent is then transferred to a single tank reactor of SMBR (2) for treatment. The treated batik effluent is then pumped (3) back to batik factory's water storage (4) to be further reused in the next cycle of Batik manufacturing processes.

Referring to FIG. 2, in the present invention, the treatment process of SMBR comprises the steps of subjecting the batik effluent to a pre-treatment phase or a solid removal phase (5) prior to entering the activated sludge process or biological phase (6). Upon completion of the biological phase (6), the partially treated effluent is then fed to the membrane filtration phase (7) for further filtering and thus obtaining a treatment effluent to ready to be disposed safely or re-use. The liquid that passes through the membrane (7) is referred to as treated batik effluent or permeate while the liquid excluded by the membrane is known as batik's particulate waste constituents or retentate. SMBR system is a continuous feed supply controlled by a buoyant water level controller which is used to ensure sufficient loading of batik effluent into the single tank reactor (2). Air scouring (8) is continuously supplying aeration intensity at the bottom of membrane module (7). This air scouring bubble is applied in the range of 1 LPM to 4 LPM to provide sufficient shear stress in order to suppress any potential foulant deposition onto the membrane surface. Besides acting as an anti fouling suppression, air scouring is also meant for oxygen supplementary for bio mass in the biological phase (6) and as well as to project a homogenous mixture between batik effluent and the bio mass.

In relation to the above, besides providing optimal aeration intensity, the method of the present invention comprises the step of obtaining a desired mixed liquor suspended solids (MLSS) thereby subjected to an MLSS analyzing process, providing the accurate or most effective hydraulic retention time (HRT), providing the accurate or most effective sludge retention time (SRT) and subjecting the batik wastes to a membrane separation sequence, said membrane separation process comprising exclusively formed membrane that is synthesized from our exclusive proprietary solution, whereby details will be described later herein.

It is further noted that for the step of obtaining desired mixed liquor suspended solids (MLSS) may comprise of conducting conventional or standard procedure so as to analyze the sampled sludge or effluent. Similar to that of the MLSS, the sludge retention time (SRT) and hydraulic retention time (HRT) may be obtained based on conventional steps or procedures.

It is understood that the efficiency of incorporating SMBR depends significantly of several factors, such factors may include but not limiting to, membrane characteristics, sludge/wastes characteristics and operating conditions such as the imposed aeration intensity, sludge retention time (SRT) and hydraulic retention time (HRT). For the method of the present invention, the above operation may be performed at a relatively negative pressure operation and at a constant transmembrane pressure (TMP) in the range of 250 mmHg (0.33 bar) to 550 mmHg (0.7 bar), whereby the partially treated batik effluent from the biological phase (6) will be filtered from the outside to inside of the membrane fibers (7).

It is noted that the treatment method in accordance to another preferred embodiment is operated at low HRT (4 hr-24 hr), SRT (16 days-30 days), high mixed liquor suspended solids concentration (4000 mg/L-7000 mg/L) and longer backwash requirement (30 days), thereby providing a high treatment efficiency of the waste effluents. In the present invention, the filtration or permeate flow rate of batik effluent is carried out according to the designed hydraulic retention time (HRT) in order to maintain the practicality and efficiency of this treatment system. The permeate flow rate is designed to range from 1.54 L/hr to 9.25 L/hr, which is technically equivalent to 24 hours and 4 hours of hydraulic retention time (HRT), respectively. The operational permeate flux is monitored over the time to determine the degree of membrane fouling to membrane permeability. Parameters used to quantify the efficiency of membrane processes are flux (J), permeability and solute rejection (R), where the flux is defined as

$$J = \frac{Q}{A} \qquad ( 1.0 )$$

where Q is the permeate flowrate (L. hr⁻¹) and A is the membrane area (m²)
and permeability as

$$Permeability = \frac{Q}{A Δ P} = \frac{Q}{N Δ Pdl π} \qquad ( 2.0 )$$

where Q is the permeate flowrate (L. hr⁻¹), A is the effective membrane area (m²), ΔP is the transmembrane pressure (Pa), N is the fiber quantity, d is the membrane OD and 1 is the membrane effective length (m), the rejection (R %) as

$$R ( \% ) = [ 1 - ( \frac{Cp}{Cf} ) ] \times 100 \qquad ( 3.0 )$$

where Cp is the permeate concentration in mg/L and Cf is the feed concentration (mg/L)

Referring to another preferred embodiment of the present invention, the method further includes the step of using a specially designed membrane, referred herein as bio-membrane.

Suitably, said membrane is formed or synthesized such that it provides total discrimination to turbidity, suspended particles, bacteria, heavy weight organic matter, dyes particulates, mordant and vat.

Referring to FIG. 2, the bio-membrane (7) is a formulation that is fabricated from polysulfone polymer (PSF), N,N-dimethylacetamide solvent and poly(vinyl) pyrrolidone (PVP) additive. Bio-membrane (7) is synthesized from our proprietary formulation that ensures total discrimination to turbidity, colloidal particles, color, suspended particles, microorganisms and other particulate materials. The membrane (7) itself has a pore size which is approximately 6 nm which is able to effectively remove contaminants such as bacteria, viruses and other impurities. Bio-membrane (7) has a pore size of approximately 6 nm which is 16 times smaller than a bacteria diameter (100 nm) and 4 times smaller than a virus size (20 nm), subsequently ensures 99.99% bacteria, viruses and other impurity discrimination. The bio-membrane (7) is synthesized from phase inversion technique using a dry-wet spinning machine. This bio-membrane (7) is fabricated from a dope formulation containing polysulfone polymer, additives and N-dimethylacetamide (DMAc) solvent. The bio-membrane (7) is used to ensure better membrane performance in terms of quality and productivity compared to the commercially available water filter. The bio-membrane (7) is 83 times better in term of separation performance than the conventional household membrane filter. This is due to its smaller pore size (approximately 6 nm or 68 kDa) compared to the commercially available filters (0.5 μm to 5 μm).

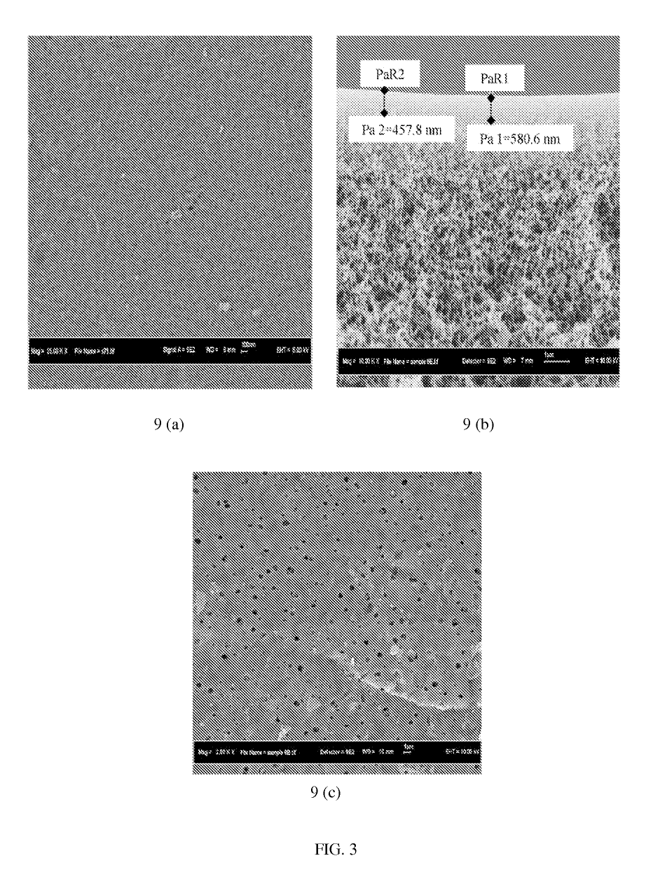

Referring to FIG. 3, the scanning electron microscope (SEM) images of clean bio-membrane hollow fiber. The as-spun bio-membrane (7) from the phase inversion process exhibited typical asymmetric structure with developed macro pores and sponge like structures that acted as micro porous mechanical support. The outer edge cross section (9a) exhibited obvious morphological differences between a dense active layer (9b) and supported micro porous structures with no visible pores can be seen at magnification of 25000×. In particular the asymmetric membrane showed pronounce morphologies with an apparent dense top layer (9b) ranges from 0.45 μm to 0.58 μm and porous sublayer which present in the form of sponge, finger like and macro voids structures. On the other hand, the inner edge cross section (9c) showed uniform micro porous pores network which apparently suggested that the membrane had an outer skin layer (9a). This morphological characteristic occurred due to a convective forced instantaneous phase separation by nitrogen air that happened from the outer surface of the nascent fiber upon extruding from the spinneret. The demixing of dope solution was even faster when the fiber went through the outer coagulation bath as water was a stronger coagulant which speed-up the instantaneous phase separation towards the inner surface. Therefore, the evolved membrane morphology is obviously dependent on the employed convective force, coagulant, polymer and solvent of spinning solution which were potential in influencing the phase separation pace as well as the membrane performance. Dope formulation has been designed to produce a high performance polysulfone bio-membrane (7) for particulate waste constituents of batik effluent. The dope composition for bio-membrane (7) is shown in Table 1.

TABLE 1
Dope formulation for bio-membrane

| Material | Concentration |
|---|---|
| Polymer; Polysulfone (Udel-P3700) | 15%-18% |
| Solvent; N,N-dimethylacetamide (Merck) | 65%-70% |
| Additive; poly (vinyl-pyrrolidone)-K30 (Fluka) | 10%-15% |

With the method of the present invention, an environmentally compliant batik effluent can be released for reusing purposes or disposal and thus safe for the surrounding.

Although the present invention has been described with reference to the preferred embodiment thereof, it is apparent to those skilled in the art that a variety of modifications and changes may be made without departing from the scope of the present invention which is intended to be defined by the appended claims.

### Example 1

This example was performed using a SMBR system in a single tank reactor (2) as shown in the FIG. 2. In the present experiment activated sludge from local municipal sludge and bio-membrane of semi-permeable membrane (7) were employed. Operational condition and process were performed as mentioned in the detailed description section. A sample of batik effluent was added to the reactor tank (2) to create a body of waste water to be treated. The batik effluent has pH of 9.3, turbidity measured as 84 NTU, color of greater than 70 ADMI, COD of 320 mg/L and BOD₅ of 95 mg/L. Suction operational transmembrane pressure was maintained at 250 mmHg/0.33 bar throughout the filtration process. Subsequently, the permeate or treated batik effluent was measured to have pH of 7.8, turbidity of 0.7 NTU, color of 18 ADMI, COD of 36 mg/L, BOD₅ of 11 mg/L and with no presence of Escherichia coli. This example showed that the present invention is capable of treating batik effluent beyond the Standard A of regulations stipulated by the Department of Environment (DOE) Malaysia.

1. A batik effluent treatment system wherein the system comprising:
batik effluent collection tank (1);
single tank reactor (2) for batik effluent treatment;
pump (3); and
treated batik factory's water storage tank (4)
characterized in that the tank reactor (2) is provided with pretreatment phase for solids removal (5), activated sludge or bio mass (6) and a bio-membrane (7) which contains 15-18% of polysulfone polymer (PSF), 65-70% of N,N-dimethylacetamide (DMAc) solvent and 10-18% of poly(vinyl)-pyrrolidone (PVP) additive.

2. The batik effluent treatment system as claimed in claim 1 wherein the bio-membrane (7) is made of hollow fiber membrane.

3. The batik effluent treatment system as claimed in claim 1 wherein the bio-membrane (7) has a pore size of approximately 6 nm.

4. The batik effluent treatment system as claimed in claim 1 is used in a batik factory treatment system for treating untreated water.

5. The batik effluent treatment system as claimed in claim 4 wherein the untreated water is textile effluent, particularly batik effluent.

6. The batik effluent treatment system as claimed in claim 1 wherein hydraulic retention time (HRT) in the single tank reactor (2) is maintained at 4 hours to 24 hours.

7. The batik effluent treatment system as claimed in claim 1 wherein sludge retention time (SRT) in the single tank reactor (2) is maintained at 16 days to 30 days.

8. The batik effluent treatment system as claimed in claim 1 wherein mixed liquor suspended solids (MLSS) in the single tank reactor (2) is maintained at 4000 mg/L to 7000 mg/L.

9. The batik effluent treatment system as claimed in claim 1 wherein air scouring system (8) is applied in the single tank reactor (2) at a flow rate of 1 L/min to 4 L/min.

10. A batik effluent treatment process wherein the process comprising the steps of:
collecting untreated batik effluent from a source into a batik effluent storage tank (1) wherein the untreated batik effluent is obtained from a source of dyeing industry such as batik effluent;
treating the stored batik effluent in a reactor (2) which is provided with pretreatment phase for solids removal (5), then partially treated by biomass in the biological phase or activated sludge (6), then filtered by the bio-membrane (7) which contains 15-18% of polysulfone polymer (PSF), 65-70% of N,N-dimethylacetamide (DMAc) solvent and 10-18% of poly(vinyl)-pyrrolidone (PVP) additive and non-solvent formulation; and
delivering the treated batik effluent to batik factory's water storage tank (4) or discharge to a public waterway.

11. The batik effluent treatment process as claimed in claim 10 wherein the bio-membrane (7) is made of hollow fiber membrane.

12. The batik effluent treatment process as claimed in claim 10 wherein the bio-membrane (7) has a pore size of approximately 6 nm.

13. The bio-membrane (7) as claimed in claim 10 is used in a batik factory treatment system for treating untreated water.

14. The bio-membrane (7) as claimed in claim 13 wherein the untreated water is batik effluent.

15. A process for synthesizing a bio-membrane (7), the process includes the steps of:
preparing bio-membrane dope solution which contains 15-18% of polysulfone polymer (PSF), 65-70% of N,N-dimethylacetamide (DMAc) solvent and 10-18% of poly(vinyl)-pyrrolidone (PVP) additive;
subjecting dope solution to dry phase separation by spinning the dope solution at selected dope extrusion rate;
subjecting the resultant solution from step (b) to dry phase separation of forced convective evaporation;
pumping the resultant solution from step (c) into a tube-in-orifice spinneret to produce pre-nascent membrane;
passing the pre-nascent membrane through a perspex;
inducing convective evaporation by blowing nitrogen steam across membrane surface;
immersing nascent skin layer in coagulation bath for wet phase separation;
collecting hollow fiber filament;
rinsing spun hollow fibers of bio-membrane to remove residual solvent;
soaking bio-membrane fibers with post treatment solution; and
air-drying bio-membrane fibers in room temperature.

16. A process for synthesizing a bio-membrane (7) as claimed in claim 15 wherein the membrane dope solution pressure is constantly maintained at 14.2 PSI.

17. A process for synthesizing a bio-membrane (7) as claimed in claim 15 wherein the membrane spinning process is carried out at ambient atmosphere of 25° C. and 84% relative humidity.

18. A process for synthesizing a bio-membrane (7) as claimed in claim 15 wherein the dry phase separation is carried out by flushing nitrogen gas (0.1 L/min) to the nascent fiber in a forced convection chamber.

19. A process for synthesizing a bio-membrane (7) as claimed in claim 15 wherein the pumping of the dope solution is carried out with gear pump motor at 0.3 cm³/rev and with dope extrusion rates (DERs) within the range of 3.0-3.5 cm³/min.

20. A process for synthesizing a bio-membrane (7) as claimed in claim 15 wherein the bore fluid of deionized water was hydraulically injected at a constant flow rate of 1.0-1.17 cm³/min using syringe pump.

21. A process for synthesizing a bio-membrane (7) as claimed in claim 15 wherein tap water is used as the coagulation medium.

22. A process for synthesizing a bio-membrane (7) as claimed in claim 15 wherein the coagulation bath temperature is controlled between 10-14° C. by refrigeration.

23. A process for synthesizing a bio-membrane (7) as claimed in claim 15 wherein the wind-up drum is measured at 17 cm in diameter.

24. A process for synthesizing a bio-membrane (7) as claimed in claim 15 wherein the applied jet stretch ratio (JS) is maintained at one.

25. A process for synthesizing a bio-membrane (7) as claimed in claim 15 wherein the post treatment solution is glycerol solution.

26. The process for synthesizing a bio-membrane (7) as claimed in claim 15 contains 15-18% of polysulfone polymer, 65-70% of N,N-dimethylacetamide (DMAc) solvent and 10-18% of poly(vinyl)-pyrrolidone (PVP) additive and non-solvent formulation.

27. The process for synthesizing a bio-membrane (7) as claimed in claim 15 wherein the bio-membrane (5) is made of hollow fiber membrane.

28. The process for synthesizing a bio-membrane (7) as claimed in claim 15 wherein the bio-membrane (7) has a pore size of approximately 6 nm.

29. The method as claimed in claim 10 wherein the resultant effluent of said method is safe to be disposed to the surrounding, whereby said effluent containing substantially reduced amount if not zero content of chemical-based materials including dyes, mordant, acid vat and direct dyes from brine.

30. The method as claimed in claim 10 wherein the resultant effluent of said method can be re-used in the next batik production process or phase.
